(19) United States
(12) Patent Application Publication
(10) Pub. No.: US 2023/0251827 A1
(43) Pub. Date: Aug. 10, 2023

(54) FLOATING-POINT UNIT AND CONFIGURATION METHOD AND DEVICE THEREOF, ARTIFICIAL INTELLIGENCE CHIP, AND ACCELERATOR

(71) Applicant: Shenzhen Corerain Technologies Co., Ltd., Shenzhen (CN)

(72) Inventors: Jiantian Liang, Shenzhen (CN); Kuen Hung Tsoi, Shenzhen (CN); Xinyu Niu, Shenzhen (CN)

(21) Appl. No.: 18/155,871

(22) Filed: Jan. 18, 2023

(30) Foreign Application Priority Data
Feb. 9, 2022 (CN) 202210121888.9

(51) Int. Cl. G06F 7/483

(52) U.S. Cl. CPC G06F 7/483

(57) ABSTRACT

A floating-point unit, a configuration method and device thereof, an artificial intelligence chip, and an accelerator. The floating-point unit is based on streaming, and includes: a data input end; N multiplexers, each including a first input end, a second input end, and a first output end, the first input end of a 1st multiplexer being connected to the data input end, the first input end of an i^{th} multiplexer being connected to the first output end of an (i−1)^{th} multiplexer, N≥2, and 2≤i≤N; N floating-point operation circuits, a 1st floating-point operation circuit being connected between the data input end and the second input end of the 1st multiplexer, and an i^{th} floating-point operation circuit being connected between the first output end of the (i−1)^{th} multiplexer and the second input end of the i^{th} multiplexer; and a data output end, connected to the first output end of an N^{th} multiplexer.

### CROSS REFERENCE TO RELATED APPLICATIONS

The present application claims the benefit of Chinese Patent Application No. 202210121888.9 filed on Feb. 9, 2022, the contents of which are incorporated herein by reference in their entirety.

### TECHNICAL FIELD

The present disclosure relates to the field of artificial intelligence technologies, and in particular, to a floating-point unit and a configuration method and device thereof, an artificial intelligence chip, and an accelerator.

### BACKGROUND

In recent years, the artificial intelligence technologies have been widely applied to various industries. However, the process of implementing the artificial intelligence technologies involves a large quantity of operations. In the related art, artificial intelligence chips may be used to complete these operations to improve operation efficiency.

### SUMMARY

However, the inventor noticed that in this manner, the operation efficiency is still relatively low.

The inventor found through analysis that when floating-point operations are performed on complex floating-point data, for example, in the process of performing operations such as whitening processing, color gamut conversion, and activation function processing on videos and images, a floating-point unit in an artificial intelligence chip completes operations based on an instruction set. That is, the next operation can only be performed after one operation is completed, and the operation efficiency is relatively low.

To resolve the foregoing problem, embodiments of the present disclosure provide the following solutions:

According to an aspect of the embodiments of the present disclosure, a floating-point unit is provided, where the floating-point unit is based on a streaming, and includes: a data input end; N multiplexers, where each of the N multiplexers includes a first input end, a second input end, and a first output end, where the first input end of a 1st multiplexer is connected to the data input end, and the first input end of an i^{th} multiplexer is connected to the first output end of an (i−1)^{th} multiplexer, N≥2, 2≤i≤N; N floating-point operation circuits, where a 1st floating-point operation circuit is connected between the data input end and the second input end of the 1st multiplexer, and an i^{th} floating-point operation circuit is connected between the first output end of the (i−1)^{th} multiplexer and the second input end of the i^{th} multiplexer; and a data output end, connected to the first output end of an N^{th} multiplexer.

In some embodiments, the floating-point unit further includes at least one group of multiplexers, where each group of multiplexers corresponds to a j^{th} floating-point operation circuit and a k^{th} multiplexer, where j is a positive integer ranging from 1 to N−1, and k is a positive integer ranging from j+1 to N; and each group of multiplexers includes: a first multiplexer, including: a second output end, connected to an end of the j^{th} floating-point operation circuit away from a j^{th} multiplexer, a third input end, connected to the data input end in a case of j=1, and connected to the first output end of a (j−1)^{th} multiplexer in a case of 2≤j≤N−1, and a fourth input end, connected to the first output end of the k^{th} multiplexer; and a second multiplexer, including: a fifth input end, connected to the first output end of the k^{th} multiplexer, a sixth input end, connected to an end of the j^{th} floating-point operation circuit close to the j^{th} multiplexer, and a third output end, connected to the first input end of a (k+1)^{th} multiplexer in a case of j+1≤k≤N−1, and connected to the data output end in a case of k=N.

In some embodiments, the at least one group of multiplexers includes a plurality of groups of multiplexers, different groups of multiplexers correspond to different j^{th} floating-point operation circuits, and different groups of multiplexers correspond to different k^{th} multiplexers.

In some embodiments, the j^{th} floating-point operation circuit corresponding to one of the at least one group of multiplexers is configured to perform a multiplication operation.

In some embodiments, the k^{th} multiplexer corresponding to the one group of multiplexers is the N^{th} multiplexer.

In some embodiments, the N floating-point operation circuits include an r^{th} floating-point operation circuit configured to perform a binocular operation, where r≥2; and the floating-point unit further includes: a data synchronization circuit, connected between the r^{th} floating-point operation circuit and the first output end of an (r−1)^{th} multiplexer, and configured to: synchronize data from the first output end of the (r−1)^{th} multiplexer and data from the first output end of a t^{th} multiplexer to the r^{th} floating-point operation circuit in a synchronous mode, where 1≤t≤r−1; and cause, in an asynchronous mode, the data from the first output end of the (r−1)^{th} multiplexer to flow to the r^{th} floating-point operation circuit through the data synchronization circuit.

In some embodiments, different floating-point operation circuits are configured to perform different types of floating-point operations.

In some embodiments, floating-point operations that the N floating-point operation circuits are configured to perform include a negation operation, a comparison operation, a logarithmic operation, a multiplication operation, an exponential operation, an addition operation, and a reciprocal operation.

In some embodiments, the logarithmic operation and the exponential operation use e as a base.

In some embodiments, the N floating-point operation circuits are configured in an initial sequence from 1 to N to perform the negation operation, the comparison operation, the logarithmic operation, the multiplication operation, the exponential operation, the addition operation, and the reciprocal operation.

According to another aspect of the embodiments of the present disclosure, a configuration method of the floating-point unit according to any one of the foregoing embodiments is provided, including: determining a first group of floating-point operations that need to be performed, where a type of each floating-point operation in the first group of floating-point operations is a type of a floating-point operation that one of the N floating-point operation circuits is configured to perform; and performing at least one configuration on a register according to a reference sequence and a first execution sequence of the first group of floating-point operations, to cause the register to control the floating-point unit to perform, in response to data from the data input end, the first group of floating-point operations, where the reference sequence includes an execution sequence of N floating-point operations performed by the N floating-point operation circuits in the initial sequence from 1 to N, and each configuration includes configuring the N multiplexers.

In some embodiments, each floating-point operation circuit is configured to: output, in an operation mode, data obtained after a floating-point operation is performed on flowing-through data, and directly output the flowing-through data in a non-operation mode, where each configuration further includes configuring each floating-point operation circuit to be in the operation mode or the non-operation mode.

In some embodiments, the performing at least one configuration on a register according to a reference sequence and a first execution sequence of the first group of floating-point operations includes: splitting the first group of floating-point operations into a plurality of second groups of floating-point operations in the first execution sequence in a case that a sequence of a plurality of floating-point operations in the first group of floating-point operations in the first execution sequence is different from that of the plurality of floating-point operations in the reference sequence, where a sequence of any two floating-point operations in each second group of floating-point operations in a second execution sequence of the second group of floating-point operations is the same as that in the reference sequence; and performing one configuration on the register for each second group of floating-point operations, to cause the register to control the floating-point unit to perform, in response to the data from the data input end, the plurality of second groups of floating-point operations.

In some embodiments, a sequence of at least two floating-point operations in a third group of floating-point operations in an execution sequence of the third group of floating-point operations is different from that of the at least two floating-point operations in the reference sequence, where the third group of floating-point operations is obtained by combining any two adjacent second groups of floating-point operations in the plurality of second groups of floating-point operations.

In some embodiments, the performing at least one configuration on a register according to a reference sequence and a first execution sequence of the first group of floating-point operations further includes: performing one configuration on the register in a case that a sequence of any two floating-point operations in the first group of floating-point operations in the first execution sequence is the same as that in the reference sequence.

In some embodiments, the floating-point unit further includes at least one group of multiplexers, where each group of multiplexers corresponds to a j^{th} floating-point operation circuit, a k^{th} multiplexer, and a k^{th} floating-point operation circuit, where j is a positive integer ranging from 1 to N−1, and k is a positive integer ranging from j+1 to N; and each group of multiplexers includes: a first multiplexer, including: a second output end, connected to an end of the j^{th} floating-point operation circuit away from a j^{th} multiplexer, a third input end, connected to the data input end in a case of j=1, and connected to the first output end of a (j−1)^{th} multiplexer in a case of 2≤j≤N−1, and a fourth input end, connected to the first output end of the k^{th} multiplexer; and a second multiplexer, including: a fifth input end, connected to the first output end of the k^{th} multiplexer, a sixth input end, connected to an end of the i^{th} floating-point operation circuit close to the j^{th} multiplexer, and a third output end, connected to the first input end of a (k+1)^{th} multiplexer in a case of j+1≤k≤N−1, and connected to the data output end in a case of k=N; and where each configuration further includes configuring the first multiplexer and the second multiplexer in each group of multiplexers; and the reference sequence further includes an execution sequence of the N floating-point operations performed by the N floating-point operation circuits in an adjustment sequence different from the initial sequence, where the adjustment sequence is an execution sequence in which the j^{th} floating-point operation circuit corresponding to each of one or more of the at least one group of multiplexers is adjusted, based on the initial sequence, to perform an operation after the corresponding k^{th} floating-point operation circuit.

In some embodiments, the N floating-point operation circuits include an r^{th} floating-point operation circuit configured to perform a binocular operation, where r≥2; and the floating-point unit further includes a data synchronization circuit connected between the r^{th} floating-point operation circuit and the first output end of an (r−1)^{th} multiplexer and configured to: synchronize data from the first output end of the (r−1)^{th} multiplexer and data from the first output end of a t^{th} multiplexer to the r^{th} floating-point operation circuit in a synchronous mode, where 1≤t≤r−1; and cause, in an asynchronous mode, the data from the first output end of the (r−1)^{th} multiplexer to flow to the r^{th} floating-point operation circuit through the data synchronization circuit; and where each configuration further includes configuring the data synchronization circuit to be in the synchronous mode or the asynchronous mode.

In some embodiments, the determining a first group of floating-point operations that need to be performed includes: splitting a formula of an operation that needs to be performed, to obtain the first group of floating-point operations.

According to still another aspect of the embodiments of the present disclosure, a configuration device of the floating-point unit according to any one of the foregoing embodiments is provided, including: a determining module, configured to determine a first group of floating-point operations that need to be performed, where a type of each floating-point operation in the first group of floating-point operations is a type of a floating-point operation that one of the N floating-point operation circuits is configured to perform; and a configuration module, configured to perform at least one configuration on a register according to a reference sequence and a first execution sequence of the first group of floating-point operations, to cause the register to control the floating-point unit to perform, in response to data from the data input end, the first group of floating-point operations, where the reference sequence includes an execution sequence of N floating-point operations performed by the N floating-point operation circuits in the initial sequence from 1 to N, and each configuration includes configuring the N multiplexers.

According to still another aspect of the embodiments of the present disclosure, a configuration device of the floating-point unit according to any one of the foregoing embodiments is provided, including: a memory; and a processor coupled to the memory, where the processor is configured to perform, based on instructions stored in the memory, the configuration method of the floating-point unit according to any one of the foregoing embodiments.

According to still another aspect of the embodiments of the present disclosure, an artificial intelligence chip is provided, including: the floating-point unit according to any one of the foregoing embodiments.

According to still another aspect of the embodiments of the present disclosure, an accelerator is provided, including: the configuration device of the floating-point unit according to any one of the foregoing embodiments; and the artificial intelligence chip according to any one of the foregoing embodiments, including the register, where the register is configured to control, according to the at least one configuration, the floating-point unit to perform, in response to data from the data input end, the first group of floating-point operations.

According to still another aspect of the embodiments of the present disclosure, a computer-readable storage medium is provided, including computer program instructions, the computer program instructions, when executed by a processor, implementing the configuration method of the floating-point unit according to any one of the foregoing embodiments.

According to still another aspect of the embodiments of the present disclosure, a computer program product is provided, including a computer program, the computer program, when executed by a processor, implementing the configuration method of the floating-point unit according to any one of the foregoing embodiments.

In the embodiments of the present disclosure, the first input end of each multiplexer in the floating-point unit is connected to the data input end of the floating-point unit or an output end of a last multiplexer, to receive data from the data input end or the last multiplexer; and one corresponding floating-point operation circuit is connected between the second input end of each multiplexer and the data input end or the output end of the last multiplexer, to receive data obtained through an operation of the one corresponding floating-point operation circuit. After each multiplexer is configured to output data from the first input end or the second input end, data inputted from the data input end can sequentially flow through floating-point operation circuits required for performing operations, so that the floating-point operation circuits perform floating-point operations on the flowing-through data in a manner of a streaming. In the manner of a streaming, the floating-point operation circuits can respectively perform floating-point operations at the same time. In this way, the required floating-point operations can be completed by using the floating-point unit with a simple structure in the manner of a streaming, thereby improving the operation efficiency.

The technical solutions of the present disclosure are further described below in detail with reference to accompanying drawings and embodiments.

### BRIEF DESCRIPTION OF THE DRAWINGS

To describe the technical solutions of the embodiments of the present disclosure or the related art more clearly, the following briefly introduces the accompanying drawings required for describing the embodiments or the related art. Apparently, the accompanying drawings in the following description show only some embodiments of the present disclosure, and a person of ordinary skill in the art may still derive other accompanying drawings from these accompanying drawings without creative efforts.

FIG. 1 is a schematic structural diagram of a floating-point unit according to some embodiments of the present disclosure;

FIG. 2 is a schematic flowchart of a configuration method of a floating-point unit according to some embodiments of the present disclosure;

FIG. 3 is a schematic structural diagram of a floating-point unit according to some other embodiments of the present disclosure;

FIG. 4 is a schematic structural diagram of a floating-point unit according to still some other embodiments of the present disclosure;

FIG. 5 is a schematic structural diagram of a configuration device of a floating-point unit according to some embodiments of the present disclosure;

FIG. 6 is a schematic structural diagram of a configuration device of a floating-point unit according to some other embodiments of the present disclosure; and

FIG. 7 is a schematic structural diagram of an accelerator according to some embodiments of the present disclosure.

### DETAILED DESCRIPTION

Various exemplary embodiments of the present disclosure are described in detail with reference to the accompanying drawings. The descriptions of exemplary embodiments are merely illustrative, and in no way constitute any limitation on the present disclosure and application or use of the present disclosure. The present disclosure may be implemented in many different forms, and is not limited to the embodiments described herein. These embodiments are provided to make the present disclosure be thorough and complete and fully convey the scope of the present disclosure to a person skilled in the art. It should be noted that unless illustrated in detail otherwise, the relative deployment of the components and steps, the components of the materials, the numerical expression and the values stated in these embodiments should be interpreted only as an example and not as a limitation.

The “first”, the “second”, and similar terms used in the present disclosure do not indicate any sequence, quantity or significance, but are used to only distinguish different components. A similar term such as “include” or “comprise” means that an element in front of the term covers an element listed behind the term, but does not exclude the possibility of covering another element. “Up”, “down”, and the like are merely used for indicating relative positional relationships. After absolute positions of described objects change, the relative positional relationships may also change accordingly.

In the present disclosure, when it is described that a specific component is located between a first component and a second component, there may or may not be an intermediate component between the specific component and the first component or the second component. When it is described that a specific component is connected to another component, the specific component may be directly connected to the another component without an intermediate component, or may not be directly connected to the another component and there is an intermediate component.

Unless otherwise specified, all terms (including technical terms or scientific terms) used in the present disclosure have the same meanings as those understood by a person of ordinary skill in the art to which the present disclosure belongs. It should be further understood that, the terms such as those defined in commonly used dictionaries are to be interpreted as having meanings that are consistent with the meanings in the context of the related art, and are not to be interpreted in an idealized or extremely formalized sense, unless expressively so defined herein.

Technologies, methods, and devices known to a person of ordinary skill in the art may not be discussed in detail, but in proper circumstances, the technologies, methods, and devices shall be regarded as a part of the specification.

It should be noted that: similar reference signs or letters in the accompanying drawings indicate similar items. Therefore, once an item is defined in one accompanying drawing, the item does not need to be further discussed in the subsequent accompanying drawings.

FIG. 1 is a schematic structural diagram of a floating-point unit according to some embodiments of the present disclosure. Each floating-point unit provided in the embodiments of the present disclosure is based on a streaming.

As shown in FIG. 1, the floating-point unit includes a data input end 100, N multiplexers 200, N floating-point operation circuits 300, and a data output end 400. N≥2, that is, the floating-point unit includes a plurality of multiplexers 200 and a plurality of floating-point operation circuits 300.

FIG. 1 shows an example of N=7. That is, the N multiplexers 200 include a 1st multiplexer 2001, a 2nd multiplexer 2002, a 3rd multiplexer 2003, a 4th multiplexer 2004, a 5th multiplexer 2005, a 6th multiplexer 2006, and a 7th multiplexer 2007 in a sequence of connection from the data input end 100 to the data output end 400.

Each multiplexer includes a first input end 201, a second input end 202, and a first output end 203. Each multiplexer may be configured to output data from the first input end 201 or the second output end 202 through the first output end 203.

Specifically, the first input end 201 of the 1st multiplexer 2001 is connected to the data input end 100, and the first input end 201 of the i^{th} multiplexer (for example, the 2nd multiplexer 2002 to the 7th multiplexer 2007) is connected to the first output end 203 of the (i−1)^{th} multiplexer (for example, the 1st multiplexer 2001 to the 6th multiplexer 2006), where 2≤i≤N. The first output end 203 of the N^{th} multiplexer (for example, the 7th multiplexer 2007) is connected to the data output end 400.

In other words, in a case of being configured to output data from the first input end 201, the 1st multiplexer 2001 outputs data inputted to the floating-point unit from the data input end 100, and the i^{th} multiplexer outputs data outputted from the first output end 203 of the (i−1)th multiplexer.

Similarly, in FIG. 1, the N floating-point operation circuits 300 include a 1st floating-point operation circuit 3001, a 2nd floating-point operation circuit 3002, a 3rd floating-point operation circuit 3003, a 4th floating-point operation circuit 3004, a 5th floating-point operation circuit 3005, a 6th floating-point operation circuit 3006, and a 7th floating-point operation circuit 3007 in a sequence of connection from the data input end 100 to the data output end 400.

Specifically, the 1st floating-point operation circuit 3001 is connected between the data input end 100 and the second input end 202 of the 1st multiplexer 2001, and the i^{th} floating-point operation circuit (for example, the 2nd floating-point operation circuit 3002 to the 7th floating-point operation circuit 3007) is connected between the first output end 203 of the (i−1)^{th} multiplexer (for example, the 1st multiplexer 2001 to the 6th multiplexer 2006) and the second input end 202 of the i^{th} multiplexer (for example, the 2nd multiplexer 2002 to the 7th multiplexer 2007).

Each floating-point operation circuit may perform a floating-point operation on flowing-through data. In some embodiments, each floating-point operation circuit automatically performs a floating-point operation on all flowing-through data. In some other embodiments, each floating-point operation circuit may be configured to be in an operation mode or non-operation mode. In the operation mode, the floating-point operation circuit may output data obtained after a floating-point operation is performed on flowing-through data; and in the non-operation mode, the floating-point operation circuit may directly output the flowing-through data. That is, in the non-operation mode, the floating-point operation circuit is equivalent to a data path, and performs no floating-point operation on the flowing-through data.

In some embodiments, each floating-point operation circuit may be configured to perform a corresponding type of floating-point operation, for example, a multiplication operation or an addition operation. It should be understood that different floating-point operation circuits 300 may be configured to perform the same type or different types of floating-point operations.

In the foregoing embodiments, the first input end 201 of each multiplexer in the floating-point unit is connected to the data input end 100 of the floating-point unit or an output end 203 of a last multiplexer, to receive data from the data input end 100 or the last multiplexer; and one corresponding floating-point operation circuit is connected between the second input end 202 of each multiplexer and the data input end 100 or the output end 203 of the last multiplexer, to receive data obtained through an operation of the one corresponding floating-point operation circuit. After each multiplexer is configured to output data from the first input end or the second input end, data inputted from the data input end can sequentially flow through floating-point operation circuits required for performing operations, so that the floating-point operation circuits perform floating-point operations on the flowing-through data in a manner of a streaming. In the manner of a streaming, the floating-point operation circuits can respectively perform floating-point operations at the same time. In this way, the required floating-point operations can be completed by using the floating-point unit with a simple structure in the manner of a streaming, thereby improving the operation efficiency.

The floating-point unit based on a streaming shown in FIG. 1 is further described below with reference to some embodiments.

In some embodiments, different floating-point operation circuits are configured to perform different types of floating-point operations. That is, in a case that the quantity of the N floating-point operation circuits 300 remains unchanged, the floating-point unit can perform more types of floating-point operations. In this way, the floating-point unit can be applicable to more different operation requirements, thereby improving the versatility of the floating-point unit.

In some embodiments, types of floating-point operations that the N floating-point operation circuits 300 are configured to perform include a negation operation, a comparison operation, a logarithmic operation, a multiplication operation, an exponential operation, an addition operation, and a reciprocal operation. In this way, the versatility of the floating-point unit can be improved.

In some embodiments, the logarithmic operation and the exponential operation use e as a base. In practice, the operation demand for logarithmic operations and exponential operations with e as a base is the highest, so that the versatility of the floating-point unit can be further improved.

In some embodiments, the N floating-point operation circuits are configured in an initial sequence from 1 to N to perform the negation operation, the comparison operation, the logarithmic operation, the multiplication operation, the exponential operation, the addition operation, and the reciprocal operation. In this way, the versatility of the floating-point unit can be further improved.

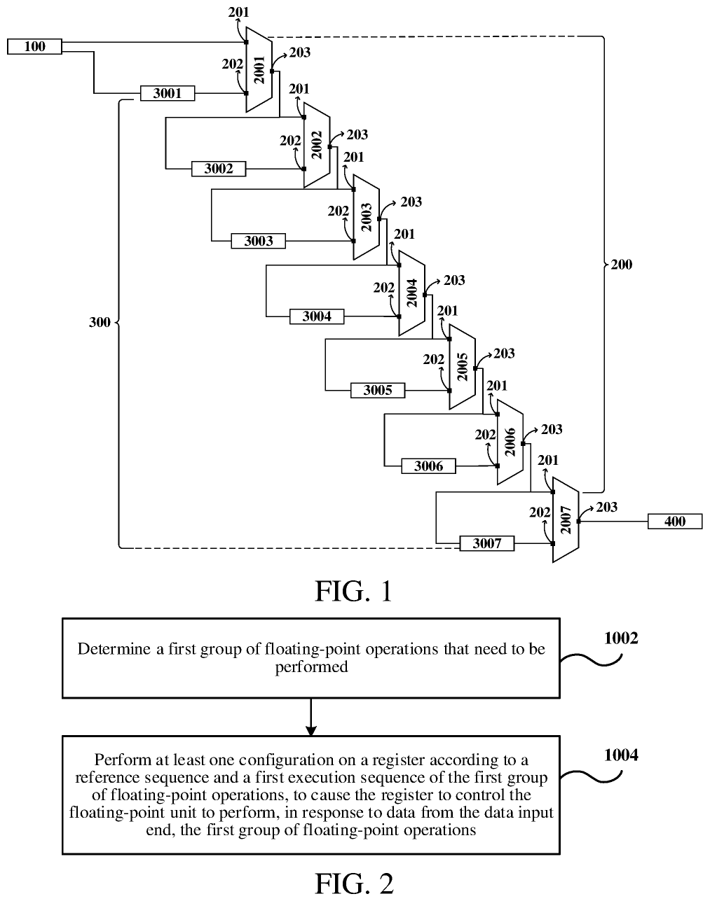

The configuration method of the floating-point unit shown in FIG. 1 is described below with reference to FIG. 2. FIG. 2 is a schematic flowchart of a configuration method of a floating-point unit according to some embodiments of the present disclosure.

As shown in FIG. 2, the configuration method of the floating-point unit includes step 1002 to step 1004.

Step 1002: Determine a first group of floating-point operations that need to be performed.

Herein, a type of each floating-point operation in the first group of floating-point operations is a type of a floating-point operation that one of the N floating-point operation circuits 300 in the floating-point unit is configured to perform.

In some implementations, a formula of an operation that needs to be performed may be split, to obtain the first group of floating-point operations.

For example, the formula of the operation that needs to be performed is

$$y = \frac{1}{{e}^{Ax} + B} ,$$

and the formula may be split into the following four operations: y1=Ax, y2=e^{y1}, y3=y2+B, and

$$y = \frac{1}{y 3} .$$

That is, the first group of floating-point operations includes four floating-point operations, and the four floating-point operations are arranged in an execution sequence (that is, a first execution sequence) as: multiplication operation, exponential operation with e as a base, addition operation, and reciprocal operation.

Step 1004: Perform at least one configuration on a register according to a reference sequence and a first execution sequence of the first group of floating-point operations, to cause the register to control the floating-point unit to perform, in response to data from the data input end, the first group of floating-point operations.

Herein, the reference sequence includes an execution sequence of N floating-point operations performed by the N floating-point operation circuits 300 in the initial sequence from 1 to N. An example of N=3 is used. It is assumed that the 1st floating-point operation circuit 3001 is configured to perform a multiplication operation, the 2nd floating-point operation circuit 3002 is configured to perform an addition operation, and the 3rd floating-point operation circuit 3003 is configured to perform a multiplication operation, then the initial sequence from 1 to N is: multiplication operation, addition operation, and multiplication operation.

Each of the at least one configuration performed on the register includes configuring the N multiplexers 200. The register is, for example, a control register of the floating-point unit. After at least one configuration is performed on the register, the register may send a control signal to each multiplexer, to configure each multiplexer to output data from the first input end 201 or the second output end 202.

In the foregoing embodiments, one group of floating-point operations that needs to be performed is determined according to the types of floating-point operations that can be performed by the N floating-point operation circuits 300. Subsequently, the register is configured according to an execution sequence of the one group of floating-point operations and an execution sequence of N floating-point operations performed by the N floating-point operation circuits 300 in a sequence from 1 to N, to cause the register to control the floating-point unit to perform, in response to data from the data input end 100, the one group of floating-point operations. In this way, the floating-point unit can be controlled to complete the one group of floating-point operations that needs to be performed in a manner of a streaming according to an actual operation requirement.

Step 1004 is further described below with reference to the embodiments.

In some embodiments, each floating-point operation circuit may be configured to: output, in an operation mode, data obtained after a floating-point operation is performed on flowing-through data, and directly output the flowing-through data in a non-operation mode. In these embodiments, each configuration further includes configuring each floating-point operation circuit to be in the operation mode or the non-operation mode. For example, a floating-point operation circuit that needs to perform a floating-point operation may be configured to be in the operation mode, and a floating-point operation circuit that does not need to perform a floating-point operation may be configured to be in the non-operation mode. In this way, the floating-point operation circuits required for operations in the floating-point unit can be controlled to perform floating-point operations, thereby improving the operation accuracy.

In some embodiments, a sequence of any two floating-point operations in the first group of floating-point operations determined in step 1002 in the first execution sequence is the same as that of the two floating-point operations in the reference sequence. In these embodiments, one configuration may be performed on the register.

The first group of floating-point operations obtained by splitting the foregoing formula is still used as an example for description. The four floating-point operations in the group of floating-point operations are arranged in the first execution sequence as: multiplication operation, exponential operation with e as a base, addition operation, and reciprocal operation. It is assumed that N=5, and the N floating-point operation circuits 300 perform the multiplication operation, the negation operation, the exponential operation with e as a base, the addition operation, and the reciprocal operation in the initial sequence from 1 to N, then the sequence of any two floating-point operations in the first group of floating-point operations in the first execution sequence is the same as that of the two floating-point operations in the reference sequence.

In this case, one configuration may be performed on the register, so that the register controls five multiplexers 200 and five floating-point operation circuits 300 in the following manner. That is: the 1st multiplexer 2001, and the 3rd multiplexer 2003 to the 5th multiplexer 2005 are controlled to output data from the second input end 202; the 2nd multiplexer 2002 is controlled to output data from the first input end 201; the 1st floating-point operation circuit 3001, and the 3rd floating-point operation circuit 3003 to the 5th floating-point operation circuit 3005 are controlled to be in the operation mode; and the 2nd floating-point operation circuit 3002 is controlled to be in the non-operation mode. After the configuration is completed, the floating-point unit can complete the first group of floating-point operations in response to the data from the data input end 100.

In the foregoing embodiments, one configuration is performed on the register in a case that a sequence of any two floating-point operations in the first group of floating-point operations in the first execution sequence is the same as that of the two floating-point operations in the reference sequence. In this way, after one configuration, the first group of floating-point operations can be completed after the data flows through the floating-point unit once, thereby further improving the operation efficiency.

In some other embodiments, a sequence of a plurality of floating-point operations in the first group of floating-point operations determined in step 1002 in the first execution sequence is different from that of the plurality of floating-point operations in the reference sequence.

In these embodiments, the first group of floating-point operations may be first split into a plurality of second groups of floating-point operations in the first execution sequence. Herein, a sequence of any two floating-point operations in each second group of floating-point operations in the execution sequence (that is, a second execution sequence) of the second group of floating-point operations is the same as that of the two floating-point operations in the reference sequence. Subsequently, one configuration is performed on the register for each second group of floating-point operations, to cause the register to control the floating-point unit to perform, in response to the data from the data input end 100, the plurality of second groups of floating-point operations.

The first group of floating-point operations in the foregoing example is still used as an example for illustration. The first group of floating-point operations is arranged in the first execution sequence as: multiplication operation, exponential operation with e as a base, addition operation, and reciprocal operation. It is assumed that N=4, and the N floating-point operation circuits 300 perform the addition operation, the reciprocal operation, the multiplication operation, and the exponential operation with e as a base in the initial sequence from 1 to N, then the sequence of a plurality of floating-point operations in the first group of floating-point operations in the first execution sequence is different from that of the plurality of floating-point operations in the reference sequence. In this case, the first group of floating-point operations may be split into two second groups of floating-point operations in the first execution sequence, which are respectively: multiplication operation and exponential operation with e as a base; and addition operation and reciprocal operation.

For the second group of floating-point operations including the multiplication operation and the exponential operation with e as a base, one configuration may be performed on the register, so that the register controls four multiplexers 200 and four floating-point operation circuits 300 in the following manner. That is: the 1st multiplexer 2001 and the 2nd multiplexer 2002 are controlled to output data from the first input end 201; the 3rd multiplexer 2003 and the 4th multiplexer 2004 are controlled to output data from the second input end 202; the 1st floating-point operation circuit 3001 and the 2nd floating-point operation circuit 3002 are controlled to be in the non-operation mode; and the 3rd floating-point operation circuit 3003 and the 4th floating-point operation circuit 3004 are controlled to be in the operation mode. Subsequently, the data input end 100 receives data, so that the floating-point unit completes the two operations of y1=Ax and y2=e^{y1} in response to the data from the data input end 100, and outputs an intermediate result.

For the second group of floating-point operations including the addition operation and the reciprocal operation, one configuration may be performed on the register again, so that the register controls four multiplexers 200 and four floating-point operation circuits 300 in the following manner again. That is: the 1st multiplexer 2001 and the 2nd multiplexer 2002 are controlled to output data from the second input end 202; the 3rd multiplexer 2003 and the 4th multiplexer 2004 are controlled to output data from the first input end 201; the 1st floating-point operation circuit 3001 and the 2nd floating-point operation circuit 3002 are controlled to be in the operation mode; and the 3rd floating-point operation circuit 3003 and the 4th floating-point operation circuit 3004 are controlled to be in the non-operation mode. Subsequently, the data input end 100 receives an intermediate result again, so that the floating-point unit completes the two operations of y3=y2+B and y=1/y3 in response to the data from the data input end 100, thereby completing the first group of floating-point operations.

In the foregoing embodiments, the first group of floating-point operations is split into a plurality of second groups of floating-point operations in a case that a sequence of a plurality of floating-point operations in the first group of floating-point operations in the first execution sequence is different from that of the plurality of floating-point operations in the reference sequence, and one configuration is performed on the register for each second group of floating-point operations. In this way, even if an execution sequence of each floating-point operation in the first group of floating-point operations is different from that of the N floating-point operation circuits 300, a plurality of configurations can still be performed on the register, so that after data flows through the floating-point unit for a plurality of times, the required first group of floating-point operations is completed.

In some embodiments, a sequence of at least two floating-point operations in a third group of floating-point operations in an execution sequence of the third group of floating-point operations is different from that of the at least two floating-point operations in the reference sequence. The third group of floating-point operations is obtained by combining any two adjacent second groups of floating-point operations in the plurality of second groups of floating-point operations. In this way, after the plurality of configurations, the required first group of floating-point operations can be completed after the data flows through the floating-point unit for the smallest quantity of times, thereby further improving the operation efficiency.

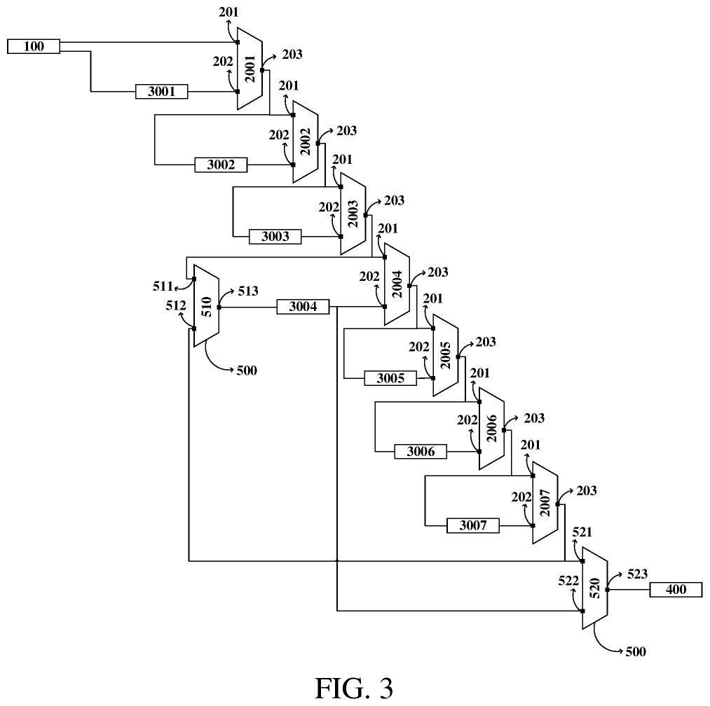

FIG. 3 is a schematic structural diagram of a floating-point unit according to some other embodiments of the present disclosure.

As shown in FIG. 3, in addition to the data input end 100, the N multiplexers 200, the N floating-point operation circuits 300, and the data output end 400, the floating-point unit further includes at least one group of multiplexers 500 (where one group is schematically shown in FIG. 3).

Each group of multiplexers 500 corresponds to a j^{th} floating-point operation circuit, a k^{th} multiplexer, and a k^{th} floating-point operation circuit. Herein, j is a positive integer ranging from 1 to N−1, and k is a positive integer ranging from j+1 to N. Each group of multiplexers 500 includes a first multiplexer 510 and a second multiplexer 520. The first multiplexer 510 includes a third input end 511, a fourth input end 512, and a second output end 513, and the second multiplexer 520 includes a fifth input end 521, a sixth input end 522, and a third output end 523.

The second output end 513 of the first multiplexer 510 is connected to an end of the corresponding j^{th} floating-point operation circuit away from a j^{th} multiplexer. The j^{th} floating-point operation circuit may be one of the 1st floating-point operation circuit 3001 to the 6th floating-point operation circuit 3006, for example, the 4th floating-point operation circuit 3004 shown in FIG. 3; and the j^{th} multiplexer may be one of the 1st multiplexer 2001 to the 6th multiplexer 2006, for example, the 4th multiplexer 2004 shown in FIG. 3.

The third input end 511 of the first multiplexer 510 is connected to the data input end 100 in a case of j=1, and connected to the first output end 203 of a (j−1)^{th} multiplexer in a case of 2≤j≤N−1. FIG. 3 shows the case of j=4, that is, the third input end 511 is connected to the first output end 203 of the 3rd multiplexer 2003.

The fourth input end 512 of the first multiplexer 510 is connected to the first output end 203 of the corresponding k^{th} multiplexer. An example in which the j^{th} floating-point operation circuit shown in FIG. 3 is the 4th floating-point operation circuit 3004 is used for description. The k^{th} multiplexer may be one of the 5th multiplexer 2005 to the 7th multiplexer 2007, for example, the 7th multiplexer 2007 shown in FIG. 3.

The fifth input end 521 of the second multiplexer 520 is connected to the first output end 203 of the corresponding k^{th} multiplexer. The sixth input end 522 of the second multiplexer 520 is connected to an end of the corresponding j^{th} floating-point operation circuit close to the j^{th} multiplexer. The third output end 523 of the second multiplexer 520 is connected to the first input end 201 of a (k+1)^{th} multiplexer in a case of +1≤k≤N−1, and connected to the data output end 400 in a case of k=N. That is, in a case of k=N, the first output end 203 of the N^{th} multiplexer 2007 is connected to the data output end 400 through the second multiplexer 520.

Similar to each multiplexer shown in FIG. 1, the first multiplexer 510 may be configured to output data from the third input end 511 or the fourth input end 512, and the second multiplexer 520 may be configured to output data from the fifth input end 521 or the sixth input end 522. By configuring the first multiplexer 510 and the second multiplexer 520, the j^{th} floating-point operation circuit can be adjusted to perform an operation after the k^{th} floating-point operation circuit.

For example, the first multiplexer 510 is configured to output data from the third input end 511, and the second multiplexer 520 is configured to output data from the fifth input end 521. In this case, the N floating-point operation circuits 300 may perform N floating-point operations in the initial sequence from 1 to N.

In another example, the first multiplexer 510 is configured to output data from the fourth input end 512, and the second multiplexer 520 is configured to output data from the sixth input end 522. In this case, the N floating-point operation circuits 300 may perform the N floating-point operations in an execution sequence in which the j^{th} floating-point operation circuit is adjusted, based on the initial sequence, to perform an operation after the k^{th} floating-point operation circuit.

In the foregoing embodiments, the floating-point unit further includes at least one group of multiplexers 500, so that the N floating-point operation circuits 300 can perform the N floating-point operations in at least two execution sequences. In this way, the possibility of completing the first group of floating-point operations after the data flows through the floating-point unit once can be improved without adding floating-point operation circuits, thereby further improving the operation efficiency.

The floating-point unit shown in FIG. 3 is further described below with reference to some embodiments.

In some embodiments, the floating-point unit includes a plurality of groups of multiplexers 500. Herein, different groups of multiplexers 500 correspond to different j^{th} floating-point operation circuits, and different groups of multiplexers 500 correspond to different k^{th} multiplexers. In this way, the N floating-point operation circuits 300 in the floating-point unit can perform the N floating-point operations in more execution sequences, so that the possibility of completing the first group of floating-point operations after the data flows through the floating-point unit once can be further improved without adding floating-point operation circuits, thereby further improving the operation efficiency.

In some embodiments, the j^{th} floating-point operation circuit corresponding to one of the at least one group of multiplexers 500 is configured to perform a multiplication operation. In these embodiments, in different execution sequences of the N floating-point operations that can be performed by the N floating-point operation circuits 300, the execution sequences of the multiplication operation are different. Because the multiplication operation is a high-frequency operation used in the process of implementing the artificial intelligence technologies, by adjusting the execution sequence of the multiplication operation, the possibility of completing the first group of floating-point operations after the data flows through the floating-point unit once can be further improved without adding floating-point operation circuits. In this way, the operation efficiency can be further improved.

In some embodiments, the corresponding j^{th} floating-point operation circuit is configured to that: the k^{th} multiplexer corresponding to the one group of multiplexers 500 that performs a multiplication operation is the N^{th} multiplexer. In these embodiments, the multiplication operation in the N floating-point operations performed by the N floating-point operation circuits 300 may be performed at the end, or may be performed at other positions than the end. In the process of implementing the artificial intelligence technologies, it is usually necessary to perform the multiplication operation at the end of the entire operation or in other positions. In this way, the possibility of completing the first group of floating-point operations after the data flows through the floating-point unit once can be further improved without adding floating-point operation circuits, thereby further improving the operation efficiency.

Based on the configuration method of the floating-point unit shown in FIG. 2, the configuration method of the floating-point unit shown in FIG. 3 is further described below.

For the floating-point unit shown in FIG. 3, each configuration performed on the register in step 1004 of the configuration method thereof further includes configuring the first multiplexer 510 and the second multiplexer 520 in each group of multiplexers 500.

In addition, the reference sequence includes not only the execution sequence of N floating-point operations performed in the initial sequence from 1 to N, but also an execution sequence of the N floating-point operations performed by the N floating-point operation circuits in an adjustment sequence different from the initial sequence.

Herein, the adjustment sequence is an execution sequence in which the j^{th} floating-point operation circuit corresponding to each of one or more of the at least one group of multiplexers 500 is adjusted, based on the initial sequence, to perform an operation after the k^{th} floating-point operation circuit corresponding to the group of multiplexers 500.

For example, N=7, and the 7 floating-point operation circuits 300 are configured in an initial sequence from 1 to N to perform the negation operation, the comparison operation, the logarithmic operation, the multiplication operation, the exponential operation, the addition operation, and the reciprocal operation. The floating-point unit includes two groups of multiplexers 500, where the first group of multiplexers 500 corresponds to j=1 and k=3; and the second group of multiplexers 500 (referring to FIG. 3) corresponds to j=4 and k=7.

In this case, the reference sequence includes an execution sequence of the N floating-point operations performed by the seven floating-point operation circuits 300 in an initial sequence from 1 to 7, that is, negation operation, comparison operation, logarithmic operation, multiplication operation, exponential operation, addition operation, and reciprocal operation.

In addition, the reference sequence further includes three adjustment sequences. The first adjustment sequence is an execution sequence in which the 1st floating-point operation circuit 3001 in the first group of multiplexers 500 is adjusted to perform an operation after the 3rd floating-point operation circuit 3003, that is, comparison operation, logarithmic operation, negation operation, multiplication operation, exponential operation, addition operation, and reciprocal operation. The second adjustment sequence is an execution sequence in which the 4th floating-point operation circuit 3004 in the second group of multiplexers 500 is adjusted to perform an operation after the 7th floating-point operation circuit 3007, that is, negation operation, comparison operation, logarithmic operation, exponential operation, addition operation, reciprocal operation, and multiplication operation. The third adjustment sequence is an execution sequence in which the 1st floating-point operation circuit 3001 in the first group of multiplexers 500 is adjusted to perform an operation after the 3rd floating-point operation circuit 3003, and the 4th floating-point operation circuit 3004 in the second group of multiplexers 500 is adjusted to perform an operation after the 7th floating-point operation circuit 3007, that is, comparison operation, logarithmic operation, negation operation, exponential operation, addition operation, reciprocal operation, and multiplication operation.

In the foregoing embodiments, by configuring the first multiplexer 510 and the second multiplexer 520 in each group of multiplexers 500, the execution sequence of the N floating-point operations performed by the N floating-point operation circuits 300 can be adjusted. In this way, after at least one configuration, the required first group of floating-point operations determined in step 1002 can be completed after the data flows through the floating-point unit for a smaller quantity of times, thereby further improving the operation efficiency.

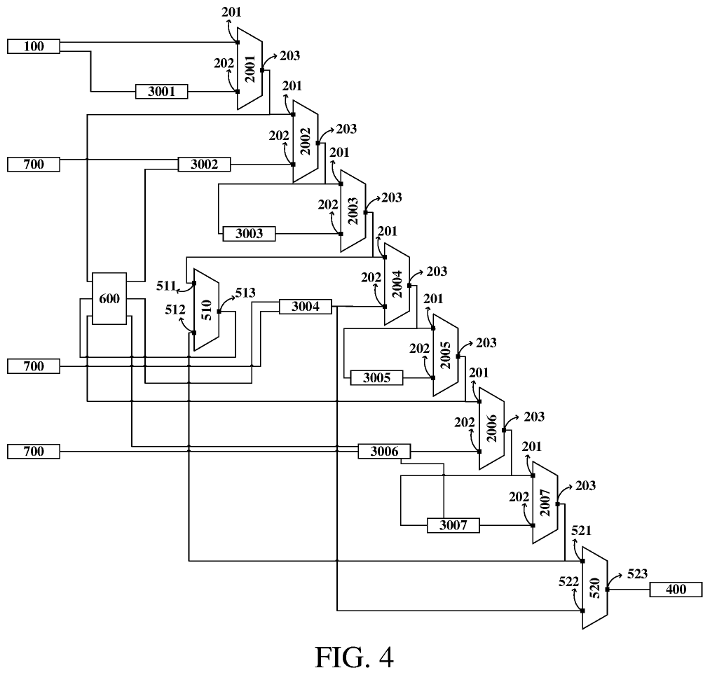

FIG. 4 is a schematic structural diagram of a floating-point unit according to still some other embodiments of the present disclosure.

In some embodiments, the N floating-point operation circuits 300 include an r^{th} floating-point operation circuit configured to perform a binocular operation, where r≥2. The binocular operation includes, but not limited to, a comparison operation, an addition operation, and a multiplication operation.

In these embodiments, as shown in FIG. 4, in addition to the data input end 100, the N multiplexers 200, the N floating-point operation circuits 300, and the data output end 400, the floating-point unit further includes a data synchronization circuit 600. The data synchronization circuit 600 is connected between the r^{th} floating-point operation circuit and the first output end 203 of the (r−1)^{th} multiplexer. FIG. 4 schematically shows that the 2nd floating-point operation circuit 3002, the 4th floating-point operation circuit 3004, and the 6th floating-point operation circuit 3006 are floating-point operation circuits configured to perform binocular operations. That is, r=2, 4 and 6. It should be understood that although FIG. 4 further shows the first multiplexer 510 and the second multiplexer 520, this is not necessary.

The data synchronization circuit 600 is configured to: synchronize data from the first output end 203 of the (r−1)^{th} multiplexer and data from the first output end 203 of a t^{th} multiplexer to the r^{th} floating-point operation circuit in a synchronous mode, where 1≤t≤r−1; and cause, in an asynchronous mode, the data from the first output end 203 of the (r−1)th multiplexer to flow to the r^{th} floating-point operation circuit through the data synchronization circuit 600. That is, in the synchronous mode, the data synchronization circuit 600 performs a synchronization operation; and in the asynchronous mode, the data synchronization circuit 600 is equivalent to a data path.

In the foregoing embodiments, the floating-point unit further includes a data synchronization circuit 600 connected between the r^{th} floating-point operation circuit configured to perform a binocular operation and the first output end 203 of the (r−1)th multiplexer, to synchronize data from the first output end 203 of the (r−1)^{th} multiplexer and the data from the first output end 203 of the t^{th} multiplexer to the r^{th} floating-point operation circuit. In this way, the r^{th} floating-point operation circuit can accurately perform a binocular operation on the two groups of data.

In some embodiments, referring to FIG. 4, the r^{th} floating-point operation circuit is further connected to the data input end 700 of the floating-point unit, and the data input end 700 is configured to receive constant data. The r^{th} floating-point operation circuit may further be configured to perform a binocular operation on data from the data synchronization circuit 600 in the asynchronous mode and constant data from the data input end 700.

In some embodiments, a floating-point operation circuit (for example, the 6th floating-point operation circuit 3006 shown in FIG. 4) configured to perform an addition operation is further connected to a floating-point operation circuit (for example, the 7th floating-point operation circuit 3007 shown in FIG. 4) configured to perform a reciprocal operation. The floating-point operation circuit configured to perform the addition operation may be further configured to send the quantity of times for which the addition is performed to the floating-point operation circuit configured to perform the reciprocal operation, so that the floating-point operation circuit configured to perform the reciprocal operation calculates an average according to the quantity of times for which the addition is performed.

Based on the configuration method of the floating-point unit shown in FIG. 2, the configuration method of the floating-point unit shown in FIG. 4 is further described below.

For the floating-point unit shown in FIG. 4, each configuration performed on the register in step 1004 of the configuration method thereof further includes configuring the data synchronization circuit 600 to be in the synchronous mode or the asynchronous mode. In this way, the r^{th} floating-point operation circuit can accurately perform the binocular operation.

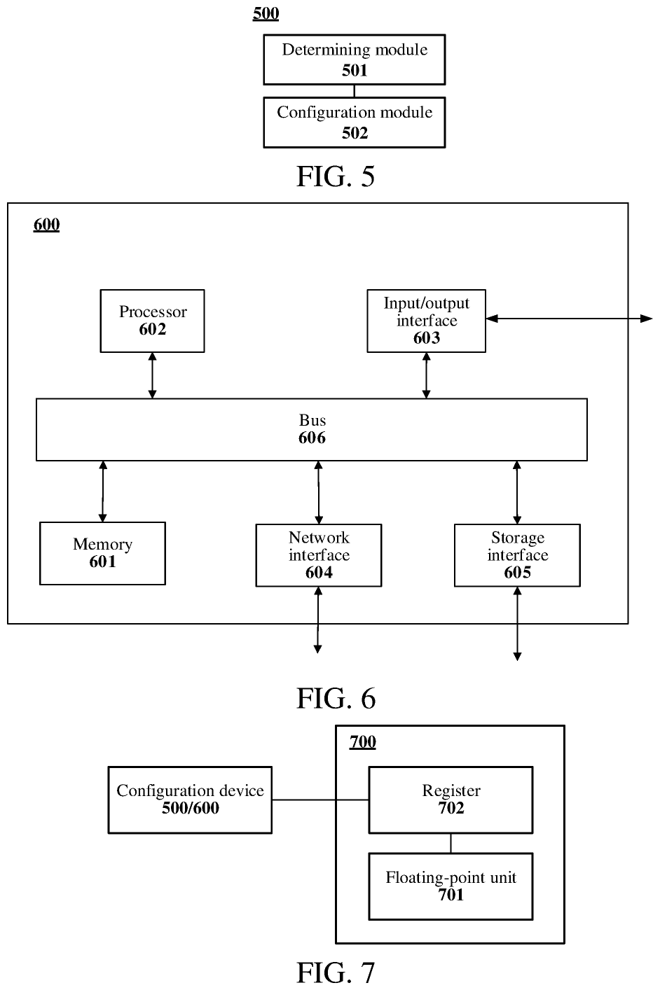

FIG. 5 is a schematic structural diagram of a configuration device of a floating-point unit according to some embodiments of the present disclosure.

As shown in FIG. 5, the configuration device 500 of the floating-point unit includes a determining module 501 and a configuration module 502.

The determining module 501 is configured to determine a first group of floating-point operations that need to be performed. Herein, a type of each floating-point operation in the first group of floating-point operations is a type of a floating-point operation that one of the N floating-point operation circuits 300 is configured to perform.

The configuration module 502 is configured to perform at least one configuration on a register according to a reference sequence and a first execution sequence of the first group of floating-point operations, to cause the register to control the floating-point unit to perform, in response to data from the data input end 100, the first group of floating-point operations. Herein, the reference sequence includes an execution sequence of N floating-point operations performed by the N floating-point operation circuits in the initial sequence from 1 to N, and each configuration includes configuring the N multiplexers 200.

It should be understood that the configuration device 500 of the floating-point unit may further include various other modules, to perform the configuration method of the floating-point unit according to any one of the foregoing embodiments.

FIG. 6 is a schematic structural diagram of a configuration device of a floating-point unit according to some other embodiments of the present disclosure.

As shown in FIG. 6, the configuration device 600 of the floating-point unit includes a memory 601 and a processor 602 coupled to the memory 601, where the processor 602 is configured to perform, based on instructions stored in the memory 601, the configuration method of the floating-point unit according to any one of the foregoing embodiments.

The memory 601 may include, for example, a system memory, a fixed non-volatile storage medium, or the like. The system memory may store, for example, an operating system, an application, a boot loader, and other applications.

The configuration device 600 may further include an input/output interface 603, a network interface 604, a storage interface 605, and the like. These interfaces 603, 604, and 605, the memory 601, and the processor 602 may be connected to each other through, for example, a bus 606. The input/output interface 603 provides a connection interface for input/output devices such as a display, a mouse, a keyboard, and a touch screen. The network interface 604 provides a connection interface for various networked devices. The storage interface 605 provides a connection interface for external storage devices such as an SD card and a USB flash drive.

The embodiments of the present disclosure further provide an artificial intelligence chip, including the floating-point unit according to any one of the foregoing embodiments.

FIG. 7 is a schematic structural diagram of an accelerator according to some embodiments of the present disclosure.

As shown in FIG. 7, the accelerator includes the configuration device of the floating-point unit (for example, the configuration device 500/600) according to any one of the foregoing embodiments, and the artificial intelligence chip (for example, the artificial intelligence chip 700 shown in FIG. 7) according to any one of the foregoing embodiments.

The artificial intelligence chip 700 includes the floating-point unit 701 and the register 702 according to any one of the foregoing embodiments. The register 702 is configured to control, according to the at least one configuration, the floating-point unit 701 to perform, in response to data from the data input end 100, the first group of floating-point operations.

The embodiments of the present disclosure further provide a computer-readable storage medium, including computer program instructions, the computer program instructions, when executed by a processor, implementing the configuration method of the floating-point unit according to any one of the foregoing embodiments.

The embodiments of the present disclosure further provide a computer program product, including a computer program, the computer program, when executed by a processor, implementing the configuration method of the floating-point unit according to any one of the foregoing embodiments.

In this way, the embodiments of the present disclosure have been described in detail. To avoid obscuring the concept of the present disclosure, some details known in the art have not been described. Based on the foregoing description, a person skilled in the art can fully understand how to implement the technical solutions disclosed herein.

The embodiments in this specification are all described in a progressive manner, and each embodiment focuses on a difference from other embodiments. For same or similar parts in the embodiments, reference may be made to each other. The embodiments of the configuration method and device, the artificial intelligence chip, and the accelerator basically correspond to the embodiment of the floating-point unit, so that the description is relatively simple. For the related parts, reference may be made to the partial descriptions of the embodiment of the floating-point unit.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. In addition, the present disclosure may use a form of a computer program product that is implemented on one or more computer-usable non-transitory storage media (including but not limited to a disk memory, a compact disc read-only memory (CD-ROM) and an optical memory) that include computer-usable program code.

The present disclosure is described with reference to flowcharts and/or block diagrams of the method, the device (system), and the computer program product in the embodiments of the present disclosure. It should be understood that a specific function in one or more processes in the flowcharts and/or in one or more blocks in the block diagrams may be implemented through computer program instructions. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some particular embodiments of the present disclosure have been described in detail based on examples, one skilled in the art should understand that the above examples are for illustration only, and are not intended to limit the scope of the present disclosure. A person skilled in the art should be understood that modifications may be made to the foregoing embodiments or equivalent replacements may be made to some technical features without departing from the scope and spirit of the present disclosure. The scope of the present disclosure is limited by the appended claims.

What is claimed is:

1. A floating-point unit, wherein the floating-point unit is based on a streaming, and comprises:
a data input end;
N multiplexers, wherein each of the N multiplexers comprises a first input end, a second input end, and a first output end, wherein the first input end of a 1st multiplexer is connected to the data input end, and the first input end of an i^{th} multiplexer is connected to the first output end of an (i−1)^{th} multiplexer, N≥2, 2≤i≤N;
N floating-point operation circuits, wherein a 1st floating-point operation circuit is connected between the data input end and the second input end of the 1st multiplexer, and an i^{th} floating-point operation circuit is connected between the first output end of the (i−1)^{th} multiplexer and the second input end of the i^{th} multiplexer; and
a data output end, connected to the first output end of an N^{th} multiplexer.

2. The floating-point unit according to claim 1, further comprising at least one group of multiplexers, wherein each group of multiplexers corresponds to a j^{th} floating-point operation circuit and a k^{th} multiplexer, wherein j is a positive integer ranging from 1 to N−1, and k is a positive integer ranging from j+1 to N; and each group of multiplexers comprises:
a first multiplexer, comprising:
a second output end, connected to an end of the j^{th} floating-point operation circuit away from a j^{th} multiplexer,
a third input end, connected to the data input end in a case of j=1, and connected to the first output end of a (j−1)^{th} multiplexer in a case of 2≤j≤N−1, and
a fourth input end, connected to the first output end of the k^{th} multiplexer; and
a second multiplexer, comprising:
a fifth input end, connected to the first output end of the k^{th} multiplexer,
a sixth input end, connected to an end of the i^{th} floating-point operation circuit close to the j^{th} multiplexer, and
a third output end, connected to the first input end of a (k+1)^{th} multiplexer in a case of j+1≤k≤N−1, and connected to the data output end in a case of k=N.

3. The floating-point unit according to claim 2, wherein the at least one group of multiplexers comprises a plurality of groups of multiplexers, different groups of multiplexers correspond to different j^{th} floating-point operation circuits, and different groups of multiplexers correspond to different k^{th} multiplexers;
wherein the j^{th} floating-point operation circuit corresponding to one of the at least one group of multiplexers is configured to perform a multiplication operation.

4. The floating-point unit according to claim 3, wherein the k^{th} multiplexer corresponding to the one group of multiplexers is the N^{th} multiplexer.

5. The floating-point unit according to claim 1, wherein the N floating-point operation circuits comprise an r^{th} floating-point operation circuit configured to perform a binocular operation, wherein r≥2; and
the floating-point unit further comprises:
a data synchronization circuit, connected between the r^{th} floating-point operation circuit and the first output end of an (r−1)^{th} multiplexer, and configured to: synchronize data from the first output end of the (r−1)^{th} multiplexer and data from the first output end of a t^{th} multiplexer to the r^{th} floating-point operation circuit in a synchronous mode, wherein 1≤t≤r−1; and cause, in an asynchronous mode, the data from the first output end of the (r−1)^{th} multiplexer to flow to the r^{th} floating-point operation circuit through the data synchronization circuit.

6. The floating-point unit according to claim 1, wherein different floating-point operation circuits are configured to perform different types of floating-point operations;
wherein floating-point operations that the N floating-point operation circuits are configured to perform comprise a negation operation, a comparison operation, a logarithmic operation, a multiplication operation, an exponential operation, an addition operation, and a reciprocal operation.

7. The floating-point unit according to claim 6, wherein the logarithmic operation and the exponential operation use e as a base;
wherein the N floating-point operation circuits are configured in an initial sequence from 1 to N to perform the negation operation, the comparison operation, the logarithmic operation, the multiplication operation, the exponential operation, the addition operation, and the reciprocal operation.

8. A configuration method of the floating-point unit according to claim 1, comprising:
determining a first group of floating-point operations that need to be performed, wherein a type of each floating-point operation in the first group of floating-point operations is a type of a floating-point operation that one of the N floating-point operation circuits is configured to perform; and
performing at least one configuration on a register according to a reference sequence and a first execution sequence of the first group of floating-point operations, to cause the register to control the floating-point unit to perform, in response to data from the data input end, the first group of floating-point operations, wherein
the reference sequence comprises an execution sequence of N floating-point operations performed by the N floating-point operation circuits in the initial sequence from 1 to N, and each configuration comprises configuring the N multiplexers.

9. The method according to claim 8, wherein each floating-point operation circuit is configured to: output, in an operation mode, data obtained after a floating-point operation is performed on flowing-through data, and directly output the flowing-through data in a non-operation mode, wherein
each configuration further comprises configuring each floating-point operation circuit to be in the operation mode or the non-operation mode.

10. The method according to claim 8, wherein the performing at least one configuration on a register according to a reference sequence and a first execution sequence of the first group of floating-point operations comprises:
splitting the first group of floating-point operations into a plurality of second groups of floating-point operations in the first execution sequence in a case that a sequence of a plurality of floating-point operations in the first group of floating-point operations in the first execution sequence is different from that of the plurality of floating-point operations in the reference sequence, wherein a sequence of any two floating-point operations in each second group of floating-point operations in a second execution sequence of the second group of floating-point operations is the same as that in the reference sequence; and
performing one configuration on the register for each second group of floating-point operations, to cause the register to control the floating-point unit to perform, in response to the data from the data input end, the plurality of second groups of floating-point operations.

11. The method according to claim 10, wherein a sequence of at least two floating-point operations in a third group of floating-point operations in an execution sequence of the third group of floating-point operations is different from that of the at least two floating-point operations in the reference sequence, wherein
the third group of floating-point operations is obtained by combining any two adjacent second groups of floating-point operations in the plurality of second groups of floating-point operations;
wherein the performing at least one configuration on a register according to a reference sequence and a first execution sequence of the first group of floating-point operations further comprises:
performing one configuration on the register in a case that a sequence of any two floating-point operations in the first group of floating-point operations in the first execution sequence is the same as that in the reference sequence.

12. The method according to claim 8, wherein the floating-point unit further comprises at least one group of multiplexers, wherein each group of multiplexers corresponds to a j^{th} floating-point operation circuit, a k^{th} multiplexer, and a k^{th} floating-point operation circuit, wherein j is a positive integer ranging from 1 to N−1, and k is a positive integer ranging from j+1 to N; and each group of multiplexers comprises:
a first multiplexer, comprising:
a second output end, connected to an end of the j^{th} floating-point operation circuit away from a j^{th} multiplexer,
a third input end, connected to the data input end in a case of j=1, and connected to the first output end of a (j−1)^{th} multiplexer in a case of 2≤j≤N−1, and
a fourth input end, connected to the first output end of the k^{th} multiplexer; and
a second multiplexer, comprising:
a fifth input end, connected to the first output end of the k^{th} multiplexer,
a sixth input end, connected to an end of the j^{th} floating-point operation circuit close to the j^{th} multiplexer, and
a third output end, connected to the first input end of a (k+1)^{th} multiplexer in a case of j+1≤k≤N−1, and connected to the data output end in a case of k=N; and wherein
each configuration further comprises configuring the first multiplexer and the second multiplexer in each group of multiplexers; and
the reference sequence further comprises an execution sequence of the N floating-point operations performed by the N floating-point operation circuits in an adjustment sequence different from the initial sequence, wherein the adjustment sequence is an execution sequence in which the j^{th} floating-point operation circuit corresponding to each of one or more of the at least one group of multiplexers is adjusted, based on the initial sequence, to perform an operation after the corresponding k^{th} floating-point operation circuit.

13. The method according to claim 8, wherein the N floating-point operation circuits comprise an r^{th} floating-point operation circuit configured to perform a binocular operation, wherein r≥2; and
the floating-point unit further comprises a data synchronization circuit connected between the r^{th} floating-point operation circuit and the first output end of an (r−1)^{th} multiplexer and configured to: synchronize data from the first output end of the (r−1)^{th} multiplexer and data from the first output end of a t^{th} multiplexer to the r^{th} floating-point operation circuit in a synchronous mode, wherein 1≤t≤r−1; and cause, in an asynchronous mode, the data from the first output end of the (r−1)^{th} multiplexer to flow to the r^{th} floating-point operation circuit through the data synchronization circuit; and wherein
each configuration further comprises configuring the data synchronization circuit to be in the synchronous mode or the asynchronous mode.

14. The method according to claim 8, wherein the determining a first group of floating-point operations that need to be performed comprises:
splitting a formula of an operation that needs to be performed, to obtain the first group of floating-point operations.

15. A configuration device of the floating-point unit according to claim 1, comprising:
a determining module, configured to determine a first group of floating-point operations that need to be performed, wherein a type of each floating-point operation in the first group of floating-point operations is a type of a floating-point operation that one of the N floating-point operation circuits is configured to perform; and
a configuration module, configured to perform at least one configuration on a register according to a reference sequence and a first execution sequence of the first group of floating-point operations, to cause the register to control the floating-point unit to perform, in response to data from the data input end, the first group of floating-point operations, wherein the reference sequence comprises an execution sequence of N floating-point operations performed by the N floating-point operation circuits in the initial sequence from 1 to N, and each configuration comprises configuring the N multiplexers.

16. A configuration device of the floating-point unit according to claim 1, comprising:
a memory; and
a processor coupled to the memory, and configured to perform, based on instructions stored in the memory, the configuration method of the floating-point unit comprising:
determining a first group of floating-point operations that need to be performed, wherein a type of each floating-point operation in the first group of floating-point operations is a type of a floating-point operation that one of the N floating-point operation circuits is configured to perform; and
performing at least one configuration on a register according to a reference sequence and a first execution sequence of the first group of floating-point operations, to cause the register to control the floating-point unit to perform, in response to data from the data input end, the first group of floating-point operations, wherein
the reference sequence comprises an execution sequence of N floating-point operations performed by the N floating-point operation circuits in the initial sequence from 1 to N, and each configuration comprises configuring the N multiplexers.

17. An artificial intelligence chip, comprising:
the floating-point unit according to claim 1.

18. An accelerator, comprising:
the configuration device of the floating-point unit according to claim 15; and
the artificial intelligence chip comprising: the floating-point unit, wherein the floating-point unit is based on a streaming, and comprises:
a data input end;
N multiplexers, wherein each of the N multiplexers comprises a first input end, a second input end, and a first output end, wherein the first input end of a 1st multiplexer is connected to the data input end, and the first input end of an i^{th} multiplexer is connected to the first output end of an (i−1)^{th} multiplexer, N≥2, 2≤i≤N;
N floating-point operation circuits, wherein a 1st floating-point operation circuit is connected between the data input end and the second input end of the 1st multiplexer, and an i^{th} floating-point operation circuit is connected between the first output end of the (i−1)^{th} multiplexer and the second input end of the i^{th} multiplexer; and
a data output end, connected to the first output end of an N^{th} multiplexer;
comprising the register, wherein the register is configured to control, according to the at least one configuration, the floating-point unit to perform, in response to data from the data input end, the first group of floating-point operations.

19. A computer-readable storage medium, comprising computer program instructions, the computer program instructions, when executed by a processor, implementing the configuration method of the floating-point unit according to claim 11.

20. A computer program product, comprising a computer program, the computer program, when executed by a processor, implementing the configuration method of the floating-point unit according to claim 11.
